(19) United States
(12) Patent Application Publication
(10) Pub. No.: US 2010/0058238 A1
(43) Pub. Date: Mar. 4, 2010

(54) Data navigation system

(76) Inventor: Avigdor Ben Moshe, Tel Aviv (IL)

Correspondence Address: ROBERT G. LEV, 4766 MICHIGAN BLVD., YOUNGSTOWN, OH, 44505, US

(21) Appl. No.: 12/231,620

(22) Filed: Sep. 4, 2008

(51) Int. Cl. G06F 3/048

(52) U.S. Cl. 715/818

(57) ABSTRACT

The present invention is a navigating system for navigating a data structure having a plurality of data fields arranged into a plurality of data arrays. The navigation system includes a display representing the contents of a subset constituted by data fields of currently selected data array. The display is also arranged to display the contents of a particular data field from the currently selected data array. The system further includes a field selector for navigating to and selecting specific data arrays and data fields within selected arrays.

### FIELD OF THE INVENTION

The present invention is directed to providing a navigation system for navigating though a data structure.

### BACKGROUND

Systems and search engines for navigating between data-fields in directories and other databases are known. Some systems provide representative identifiers, such as thumbnail images or the like, which are associated with the data contents of data-fields within the database. Such representative identifiers may help a user to find specific data contents within the database.

For example, thumbnail images are used in the navigation system incorporated in Apple's iPhone®. When the display screen is relatively small, although a user may still be able to view a thumbnail associated with a data-field it may be difficult for the user to identify where, within the database, the data-field is situated. Indeed, for some users, even those systems having large screens exhibiting navigable directories can be difficult to navigate. Known position indicators, such as address bars and data-trees may not be suitable for all data structures and are not very intuitive. One cause of confusion is the lack of indication as to direction of navigation.

By way of example, the iPhone® has only one physical button for basic functions. Thus in order to navigate a database using the iPhone® the user typically interfaces with an inbuilt touch-screen. Whilst designed for convenience, the touch screen may nevertheless be perceived by some users as lacking user friendliness. The iPhone® does have a virtual keyboard but it is only displayed when holding the apparatus in a vertical orientation, and as a result, a user can type comfortably with only one finger at a time. Moreover, users with, for example, long fingernails or wide fingers may become frustrated with error-prone browsing, searching and navigating.

When using a touch screen with a small display area, it can be tedious to scroll through long data arrays, such as the internal phone book or stored music play data arrays in iPhone®'s, mp3 players etc. Flicking with a finger in an up or down motion will only partially traverse up or down the data array. For example, one cannot generally move directly up or down to the top or bottom of the data array, by swiping and holding a finger on the screen.

Most computer screens are not touch screens, and their display is typically controlled and changed in response to input from separate user interface devices such as keypads, mice, joysticks or the like. Indeed, most users tend to prefer real keyboards, as they like the tactile feedback typically lacking in touch screens. Nevertheless navigating data structures and manipulating data records even in systems having regular screens can be complicated. This is especially the case when navigating large databases using a small display screen. Many such systems lack user feedback regarding the direction of traversal of the data structure.

There is a need for a user friendly data navigation system which indicates to the user where a selected data-field is situated in relation to a larger data structure. The present invention addresses this need.

### SUMMARY OF THE INVENTION

It is an aim of the invention to provide a navigation system for navigating around or through a data structure, the data structure comprising a plurality of data-fields arranged into a plurality of data-arrays, the navigation system comprising:
a display panel for representing the contents of a subset of the data-fields of a currently-selected data-array;
a data-display for displaying the contents of a currently-selected data-field from the currently-selected data-array;
a field-selector comprising: a data-array selector for navigating to and selecting data-arrays, and a data-field selector for navigating to and selecting data-fields within the currently-selected data-array.

Typically, each data-array has a unique ordinal within said data structure and the data-array selector comprises:
a FORWARD data-array selector for navigating to and selecting a data-array with an ordinal higher than the ordinal of the currently-selected data-array; and
a BACK data-array selector for navigating to and selecting a data-array with an ordinal lower than the ordinal of the currently-selected data-array;

Preferably, each data-field has a unique ordinal within a data-array and the data-field selector comprises:
a NEXT data-field selector for navigating to and selecting a data-field in the currently-selected data-array having an ordinal higher than the ordinal of the currently-selected data-field; and
a PREVIOUS data-field selector for navigating to and selecting a data-field in the currently-selected data-array having an ordinal lower than the ordinal of the currently-selected data-field.

Optionally, the display panel comprises a plurality of cells, each the cell containing a representation of the contents of one data-field, the data-fields being assigned to cells such that adjacent cells are assigned to data-fields having consecutive ordinals. In preferred embodiments the representation of the contents of the data-field is selected from at least one of the group comprising: metadata, text, a label, a content summary, an image, a number, an icon and an ordinal. Optimally, the data-field is cyclical with the highest ordinal and the data-field with the lowest ordinal are assigned to adjacent cells.

Typically, the data-display panel comprises a highlighted cell containing a representation of the contents of the currently-selected data-field. The highlighted cell may be contrasted from others by at least one emphasis selected from the group comprising: contrasting font color, font type, font size, font style, cell size, outline color, outline thickness, background color and animation.

Optionally, the field-selector comprising at least one of the group comprising: scroll bars, roller balls, keys, computer mice, active screens, active regions of a touch screen and eye tracking systems. Preferably the field-selector is lockable or switchable between ON and OFF modes.

In preferred embodiments a data viewer is provided for reviewing the contents of the currently-selected data-field. The data viewer may be selected from the group comprising: media players, word processors, web browsers, image displays, text displays, photo editors and calendars, for example. Optionally, a data editor may be provided for editing the contents of the currently-selected data-field is provided. Preferably, the contents of said currently-selected data-field are accessible by standard programs.

Optionally, the navigation system further comprises at least one further navigation means selected from the group comprising:
a search line for inputting a search string such that a data-field with contents most similar to the search string is selected;
a history bar for displaying historical shortcut links to data-fields most recently selected, such that a user may be able to select previously selected data-fields by clicking upon the historical shortcut links;
a favorites bar for displaying favorite shortcut links to data-fields most frequently selected, such that a user may be able to select frequently selected data-fields by clicking upon the favorite shortcut links; and
an address bar for displaying a directory path indicating a location of the currently-selected data-field.

Optionally, the navigation system is adapted to navigate a hierarchical data structure wherein the data-array selector comprises:
a FORWARD data-array selector for navigating to a child data-array the child data-array being a descendent of the currently-selected data-field; and
a BACK data-array selector for navigating to a parent data-array, the parent being an ancestor of the currently-selected data-array.

Alternatively, the navigation system is adapted to navigate a web type data structure wherein the data-array selector comprises:
a FORWARD data-array selector for navigating to a child data-array the child data-array being a descendent of the currently-selected data-field; and
a BACK data-array selector for navigating to a parent data-array, the parent being an ancestor of the currently-selected data-field.

### BRIEF DESCRIPTION OF THE FIGURES

For a better understanding of the invention and to show how it may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention; the description taken with the drawings making apparent to those skilled in the art how the several forms of the invention may be embodied in practice. In the accompanying drawings:

FIG. 1 shows a prior art nodal tree-type data-structure which is navigable by a navigation system according to embodiments of the present invention;

FIG. 2 shows a non-nodal parallel-array data-structure which is navigable by a navigation system according to embodiments of the present invention;

FIG. 3 shows a navigation system having a scrollbar field-selector according to a first embodiment of the current invention; and

FIG. 4 shows a navigation system having a display panel field-selector according to a second embodiment of the current invention.

### DESCRIPTION OF THE PREFERRED EMBODIMENTS

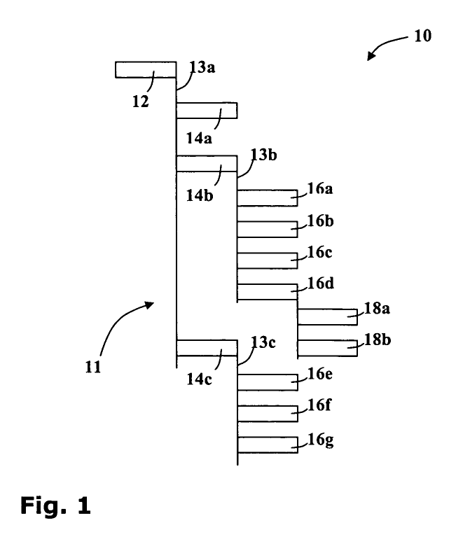

Reference is now made to FIG. 1 showing a nodal tree-type data-structure 10 of the prior art. In the tree-type data-structure 10, data-fields are arranged at the nodes 12, 14, 16, 18 of a data-tree 11. Data contents, such as digital files or the like, may be assigned to any data-field at any node 12, 14, 16, 18 in the data tree 11.

The ultimate ancestor of the tree 11 is a root-node 12 which branches out into a plurality of first level child-nodes 14a-c. The first level child-nodes 14a-c may themselves be parent nodes 14b-c, which branch into second level child-nodes eg. 16a-g. Alternatively, a child-node may be a childless terminal node eg. 14a. Similarly, a second level child-node 16d may further branch into third level nodes 18a-b and so on.

It will be appreciated that a user, navigating around such a nodal tree-type data structure 10, may navigate along the branches 13. However when the user navigates down to a terminal node 14a, 16a-c, 16e-g, 18a-b it is necessary for the user to return up the branch 13 before navigating down another branch. Such doubling back can be inconvenient for a user.

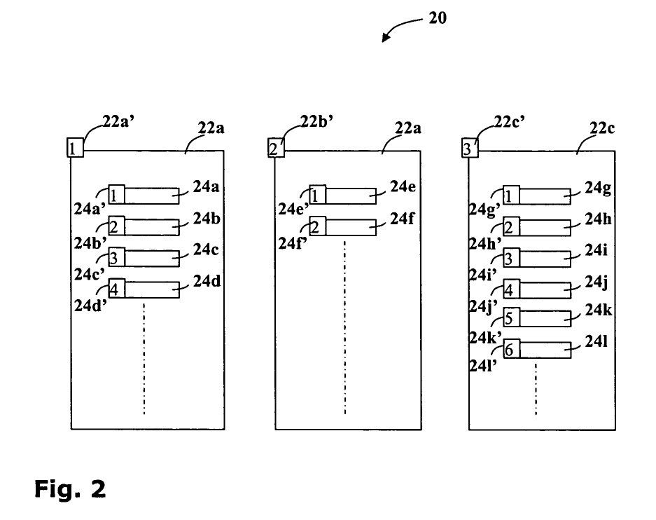

With reference to FIG. 2, an alternative data structure, specifically a non-nodal parallel-array data-structure 20 is shown. In the parallel-array data-structure 20 data-fields 24 are arranged in parallel data-arrays 22. It is noted that not all data-arrays 22 necessarily contain the same number of data-fields 24. Certain embodiments of the current invention provide a navigation system for navigating around such a data-structure 20.

Navigation of the non-nodal parallel-array data-structure 20, may be aided by a particular feature of embodiments of the current invention, namely that the data-arrays 22 and data-fields 24 may be ordered sequentially. In such embodiments, each data-field 24 is assigned an ordinal 24′ determining its position within the data-array 22. Likewise, each data-array 22 is assigned an ordinal 22′ determining its position in the data structure 20.

It is noted that the traversal by users of such data structures as the tree-type 10 or of the non-nodal parallel-array 20, as well as the interaction of the data contents of data fields therein may be confusing for the user. This is particularly the case when the user is unfamiliar with the navigation systems and where there is a lack of feedback regarding their location within the data structure. Indeed in some navigation systems, a slightly exaggerated or inadvertent movement by the user can cause unwanted effects such as losing the desired location within the database, making changes to an object located within the database or even exiting the navigation system entirely.

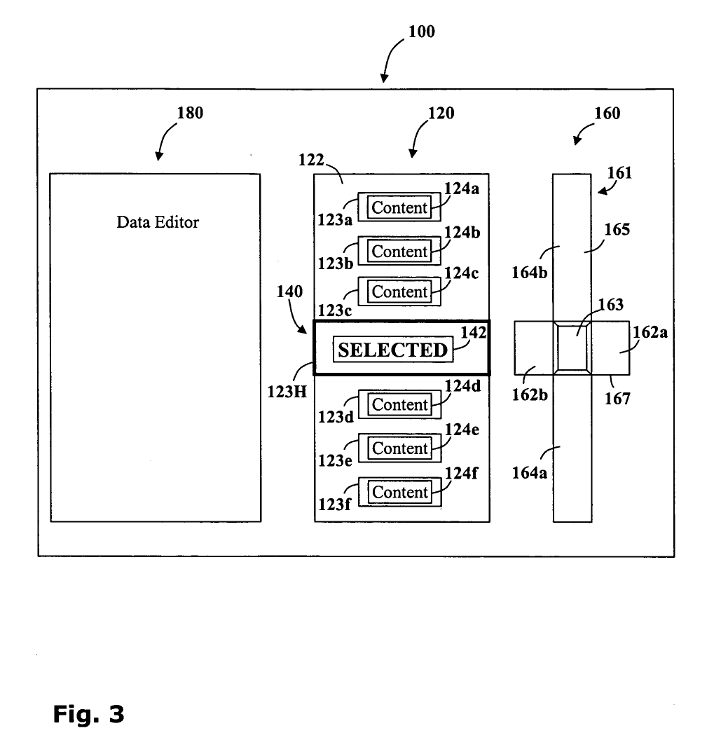

Reference is now made to FIG. 3 showing a navigation system 100 for navigating around a data-structure according to a first embodiment of the current invention. The navigation system 100 consists of a display panel 120, a data-display frame 140, a scrollbar field-selector 160 and a data viewer 180. As described hereinbelow, various features of the navigation system 100 significantly reduce the time taken for a user to locate data from within the data-structure.

The Display Panel

The display panel 120 may be used for displaying a representation 122 of the contents of a selected data-array 22 (FIG. 2). Where the data structure is hierarchical such as the tree-type nodal data structure 10 (FIG. 1) the data-array 22 may for example, be a set of sibling child-nodes 14a-c, 16a-d, 16e-g, 18a-b. The representation is typically a list of cells 123 containing content items 124, each content item 124 representing the contents of one data-field 24 of the data-array 22 (FIG. 2). In some embodiments the display panel 120 may display all the data-fields 22 of the selected data-array 24. Alternatively, the display panel 120 displays only a subset of the data-fields 24 of the selected data-array 22. Preferably, data-fields are assigned to cells such that adjacent cells within the list are assigned to data-fields having consecutive ordinals.

The Data-Display

The data-display 140 displays a selected content item 142 representing the contents of one data-field 24 selected from the selected data-array 22. The content items 124, 142 are typically an identifier such as a label, keyword, icon, image, thumbnail, ID number or the like, which a user may use to readily determine the data contained within the data-field 24. Furthermore, content items 124, 142 may include any form of metadata. Typically, the content items 124, 142 include visual indications which are easy for a user to scan by eye at high speed. In preferred embodiments, preview files containing data pertaining to such visual indications as thumbnail images, icons or the like, may be stored in an index such that they are quickly retrievable when needed by a user. For example, in a case where a data-field contains a set of photographs, a first content item which may be a title such as “Family Photos” is highlighted in the data-display and further content items may also be displayed. Additional content items may include, for example a thumbnail image of a photograph and a descriptive note such as “Tom's Birthday Party”. It will be appreciated that such content items may themselves be editable.

The data-display 140 may be a highlighted cell 123H. Preferably, the data-display 140 remains in one place upon the screen such that a user may scan content items 124 at high speed by concentrating only upon the area of the data-display 140 without having to move their eyes up and down the screen. The highlighted cell 123H may be emphasized by some highlighting means, for example, contrasting font color, font type, font size, font style, italicizing, bolding, underlining, cell size, outline color, outline thickness, background color, enlarging, changing or the like. Alternatively, emphasis may provided by animation effects: flashing, animating the font and/or the background.

The visual representation of the data-display 140 against the background of the display panel 120 provides a user with an intuitive visual representation of the location of the selected data-field 24 within the selected data-array 22. The user is therefore easily able to identify the position of the selected data-field 24 within the data-structure.

Field Selector

The field selector 160 is provided to allow the user to navigate around the data-structure. The field selector 160 consists of a data-array selector 162, and a data-field selectors 164. The data-array selector 162 allows a user to navigate to and select a data-array 22 to be displayed in the display-panel 120. The data-field selector 164 allows a user to navigate to and select a data-field 24, from the selected data-array 22, to be displayed in the data-display frame 140. It will further be appreciated that a user may navigate around the data-structure by using the field selector 160 to change the selected data-arrays and data-fields, thereby changing the visual representation of the display panel 120.

The field selector 160 of a first embodiment of the invention consists of a scrollbar 161 having a slider 163 which may be moved along a vertical track 165. The position of the slider 163 against the background of the vertical track 165 may represent the position of the selected data-field within the selected data-array. It is a particular feature of the first embodiment of the invention that the slider 163 may additionally be moved laterally along a horizontal track 167.

Moving the slider 163 along the horizontal track 167 may be used to control the data-array selector 162. For example, the right-region 162b of the horizontal track 167 to the right of the slider 163 may be configured to behave as a FORWARD data-array selector. A data-array 22 having an ordinal 22′ (FIG. 2) higher than the ordinal of the selected data-array may be selected using the FORWARD data-array selector. For example, either by dragging the slider 163 into the right-region 162b of the horizontal track 167, or by clicking in the right-region 162b of the horizontal track 167.

Similarly, the left-region 162a of the horizontal track 167 to the left of the slider 163 may be configured to behave as a BACK data-array selector. A data-array 22 having an ordinal 22′ (FIG. 2) lower than the ordinal of the selected data-array may be selected using the BACK data-array selector, perhaps by by dragging the slider 163 into the left-region 162a of the horizontal track 167, or by clicking in the left-region 162a of the horizontal track 167.

It will be appreciated that where the data-array 22 is a set of sibling child-nodes 14a-c, 16a-d, 16e-g, 18a-b of a tree-type nodal data structure 10 (FIG. 1), the BACK data-array selector may be used to select the family of the parental node. Typically, in hierarchical structures such as the tree-type data structure 10, the data-array selected when using the FORWARD data-array selector is dependent upon the selected data-field.

Since each data-array 22 typically contains a plurality of data-fields 24, a default data-field 24 is typically preselected from each data-array 22 when building or maintaining the database, such that a data-array 22 is first selected and the contents of the associated default data-field are initially displayed in the data-display frame 140.

Moving the slider 163 along the vertical track 165 may be used to control the data-field selector 164. The lower-region 164a of the vertical track 165 below the slider 163 may be configured to behave as a NEXT data-field selector. A data-field 24 having an ordinal 24′ (FIG. 2) higher than the ordinal of the selected data-array may be selected using the NEXT data-array selector. For example either by clicking in the lower-region 164a of the vertical track 167 above the slider 163, or by dragging the slider 163 into the lower-region 164a of the vertical track 167.

Similarly, the upper-region 164b of the vertical track 165 below the slider 163 may be configured to behave as a PREVIOUS data-field selector. A data-field 24 having an ordinal 24′ (FIG. 2) lower than the ordinal of the selected data-array may be selected using the PREVIOUS data-array selector, for example either by clicking in the upper-region 164b of the vertical track 167 above the slider 163, or by dragging the slider 163 into the upper-region 164b of the vertical track 167.

In preferred embodiments, the selected content item 142 changes in the direction that the slider 163 is moved. It is further noted that optionally the slider 163 may further control the scroll-speed, which is the rate at which the selected content item 142, displayed in the data-display 140, changes. Typically, the scroll-speed is increased by dragging the slider 163 further from its central position. It will be appreciated that such a configuration may be intuitive to a user navigating through the data-structure.

In other embodiments, the scrolling direction may be further indicated by displaying an indication arrow and/or by changing the color of the display panel 120, data-display frame 140 or field-selector 160, for example. Furthermore, the scrolling speed (the rate of the change of the selected data-field 24) may be indicated, for example by changing the color of elements of the field-selector 160, the change being in relation to the scroll-speed. Alternative, indicating means may occur to the man of the art.

In preferred embodiments, some elements of the navigation system is configured to be cyclical whereby for example, the data-field with the highest ordinal and the data-field with the lowest ordinal are assigned to adjacent cells 123 within the display panel 120. In such embodiments, a user may scroll through the data-fields associated with a single data-array by using the NEXT selector 164a only. Once the user reaches the data-field with the highest ordinal, the next data-field displayed will be the data-field with the lowest ordinal. Similarly, using the PREVIOUS selector 164b, the data-field displayed after the data-field with the lowest ordinal will be the data-field with the highest ordinal.

Furthermore, the data-arrays may also be arranged cyclically, using the FORWARD selector 162b when the selected data-array has the highest ordinal will select the data-array with the lowest ordinal. In a similar manner, using the BACK selector 162a when the selected data-array has the lowest ordinal, the data-array with the highest ordinal is selected.

It is further noted that in preferred embodiments of the cyclical navigation system a visual indication is provided between the data-field with the highest ordinal and the data-field with the lowest ordinal. It will be appreciated that such a visual indicator serves to separate the beginning of the data-array from the end of the data-array such that a user may easily identify when the end of the data-array has been reached. Similarly, a visual indication may be provided between the data-array with the highest ordinal and the data-array with the lowest ordinal.

Although the field-selector 160 of the first embodiment described hereabove is a scrollbar 161, in other embodiments, alternative field-selectors may be preferred. For example, other user controls known in the art may be used to control the field-selectors including: software controls such as mouse-clickable regions (buttons) of a graphical user interface, active screen control mechanisms such as the active regions of a touch screen and the like. Additionally or alternatively, the field selectors may be hardware user input devices such as roller balls, key pads, computer mice, eye trackers and the like.

Data Viewer

In some embodiments, a data viewer 180 may be provided for viewing further contents of the selected data-field 24 displayed in the data-display 140. The data viewer 180 may allow a user to review or interact with the data stored in the selected data-field 24. For example the data viewer 180 may be selected from the group comprising: media players, word processors, web browsers, image displays, text displays photo editors, calendars etc . . . . Preferably, the data-viewer 180 may be able to display the contents of multiple data-fields 24 simultaneously, multiple display methods include, tabs, windows, panels and other methods which may occur to the man of the art.

It will be appreciated that selecting a data-field may open a standard program such as any associated program in which the data contents may be configured to run. For example, if the content is a media file an external media player may be opened and if the content is a text document a word processor may be opened.

It is a further embodiment of the invention, when a data-field is selected, the content is opened in an associated program and the field selector is deactivated and hidden from view. For example, when deactivated, the field selector may be configured to slide out of the viewing frame of the video display unit.

In some embodiments the data viewer additionally provides a user with editorial functionality over at least some selected data. Editing privileges may be awarded to users in a limited manner, such as allowing the changing of viewing preferences relating to identifier, font type or the like. In other embodiments a data editor may offer the user all the functionality required to edit the contents of the data field 14. In still other embodiments, each user has a specific set of permissions, such that some users having full functionality and others being provided with only limited functionality. For example, the data contents may be a record, a field, a data file, an entry, a sound file, a movie, a spreadsheet, a word-processor document, a computer program, editable text, an image, combinations thereof or the like.

Preferably, the field-selector 160 is lockable, or otherwise switchable between ON and OFF modes, such that when locked it is impossible to change the data-field contents displayed in the data display 140. It will be appreciated that such a lockable feature is useful, particularly when a user has access to the data editor. Indeed in some embodiments, the data editor is only activated by the locking of the field selector 160.

Other embodiments of the navigation system 100 may include further navigational aids such as:
a) A search line for a user to input a search string, the navigation system being configured to select a data-field with contents most similar to those of the search string. In some embodiments, the data-field is selected from within the selected data-array, alternatively a search result may be selected from within the entire data structure.
b) A history bar, displaying the data-fields most recently selected. Preferably, the user may be able to select previously selected data-fields by clicking upon a shortcut.
c) A favorites bar, displaying the data-fields most often selected by the user.

The favorites may be user selected, automatically selected or a mixture of the two. Preferably, the user may be able to select favorite data-fields by clicking upon a shortcut.
d) More than one content item 124 for each data-field so that thumbnails or the like may be displayed alongside other data identifiers for providing alternative previews of the contents of the data-fields.
e) An address bar, displaying the directory path indicating the location of a content item. Such an address bar may provide a user with a further aid to orientation within the data structure.

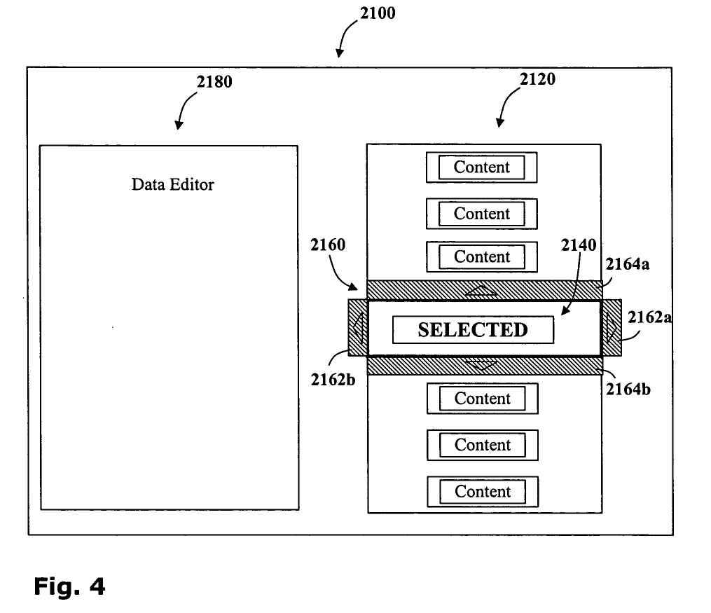

A second embodiment of the navigation system 2100 is shown in FIG. 4. The navigation system of the second embodiment consists of a display panel 2120, a data-display panel 2140, a field selector 2160 and a data viewer 2180.

Unlike the scrollbar field-selector 160 of the first embodiment, the field selector 2160 of the second embodiment is integrated into the display-panel 2120 itself. The display-panel field-selector 2160 of the second embodiment includes selection buttons 2162, 2164 arranged around the data-display frame 2124. The selection buttons include: a FORWARD data-array selector 2162b, a BACK data-array selector 2162a, a NEXT data-field selector 2164a and a PREVIOUS data-field selector 2164b. In certain embodiments the data-display frame 2124 may be slidable either up-and-down or side-to-side to control the field-selector 2160 in a manner similar to the slider 163 (FIG. 3) in the scrollbar 161 of the first embodiment. Further control arrangements will be apparent to the man of the art.

It is further noted that in other embodiments of the invention, the navigation system may be adapted to navigate through a hierarchical data structure such as is shown in FIG. 1. It is a feature of such a hierarchical data structure navigation system that a FORWARD data-array selector is provided for navigating to and selecting a child data-array, which is a descendent of the selected data-field. A BACK data-array selector is provided for navigating to and selecting a parent data-array. It is noted that in a hierarchical data-structure the parent data-array is the common ancestor of all data-fields in the selected data-array. Thus the FORWARD data-array selector is dependent upon the selected data-field, whereas the BACK data-array selector is dependent only on the selected data-array.

In other embodiments both the FORWARD and BACK data-array selectors may be dependent of the selected data-field, such embodiments may be preferred for navigating through web type data-structures.

It will be appreciated that various features described here above can be combined or modified in various ways thus, the scope of the present invention is defined by the appended claims and includes both combinations and sub combinations of the various features described hereinabove as well as variations and modifications thereof, which would occur to persons skilled in the art upon reading the foregoing description.

In the claims, the word “comprise”, and variations thereof such as “comprises”, “comprising” and the like indicate that the components listed are included, but not generally to the exclusion of other components.

I claim:

1. A navigation system for navigating a data structure, said data structure comprising a plurality of data-fields arranged into a plurality of data-arrays, said navigation system comprising:
a. a display panel for representing the contents of a subset of the data-fields of a currently-selected data-array;
b. a data-display for displaying the contents of a currently-selected data-field from said currently-selected data-array;
c. a field-selector comprising: a data-array selector for navigating to and selecting data-arrays, and a data-field selector for navigating to and selecting data-fields within said currently-selected data-array.

2. The navigation system of claim 1 wherein each data-array has a unique ordinal within said data structure and said data-array selector comprises:
a. a FORWARD data-array selector for navigating to and selecting a data-array with an ordinal higher than the ordinal of said currently-selected data-array; and
b. a BACK data-array selector for navigating to and selecting a data-array with an ordinal lower than the ordinal of said currently-selected data-array;

3. The navigation system of claim I wherein each data-field has a unique ordinal within a data-array and said data-field selector comprises:
a. a NEXT data-field selector for navigating to and selecting a data-field in said currently-selected data-array having an ordinal higher than the ordinal of said currently-selected data-field; and
b. a PREVIOUS data-field selector for navigating to and selecting a data-field in said currently-selected data-array having an ordinal lower than the ordinal of said currently-selected data-field.

4. The navigation system of claim 1, said display panel comprising a plurality of cells, each said cell containing a representation of the contents of one data-field, said data-fields being assigned to cells such that adjacent cells are assigned to data-fields having consecutive ordinals.

5. The navigation system of claim 4 wherein said representation of the contents of said data-field is selected from at least one of the group comprising: metadata, text, a label, a content summary, an image, a number, an icon and an ordinal.

6. The navigation system of claim 4 being cyclical wherein the data-field with the highest ordinal and the data-field with the lowest ordinal are assigned to adjacent cells.

7. The navigation system of claim 1, said data-display panel comprising a highlighted cell containing a representation of the contents of said currently-selected data-field.

8. The navigation system of claim 7 wherein said highlighted cell being contrasted from others by at least one emphasis selected from the group comprising: contrasting font color, font type, font size, font style, cell size, outline color, outline thickness, background color and animation.

9. The navigation system of claim 1 said field-selector comprising at least one of the group comprising: scroll bars, roller balls, keys, computer mice, active screens, active regions of a touch screen and eye tracking systems.

10. The navigation system of claim 1 wherein said field-selector is lockable.

11. The navigation system of claim 1 wherein said field-selector is switchable between ON and OFF modes.

12. The navigation system of claim 1 additionally comprising a data viewer for reviewing the contents of the currently-selected data-field.

13. The navigation system of claim 12 wherein said data viewer is selected from the group comprising: media players, word processors, web browsers, image displays, text displays, photo editors and calendars.

14. The navigation system of claim 1 wherein the contents of said currently-selected data-field are accessible by standard programs.

15. The navigation system of claim 1 additionally comprising a data editor for editing the contents of the currently-selected data-field.

16. The navigation system of claim 1 additionally compromising at least one further navigation means selected from the group comprising:
a. a search line for inputting a search string such that a data-field with contents most similar to said search string is selected;
b. a history bar for displaying historical shortcut links to data-fields most recently selected, such that a user may be able to select previously selected data-fields by clicking upon said historical shortcut links;
c. a favorites bar for displaying favorite shortcut links to data-fields most frequently selected, such that a user may be able to select frequently selected data-fields by clicking upon said favorite shortcut links; and
d. an address bar for displaying a directory path indicating a location of said currently-selected data-field.

17. The navigation system of claim 1 adapted to navigate a hierarchical data structure wherein said data-array selector comprises:
a. a FORWARD data-array selector for navigating to a child data-array said child data-array being a descendent of said currently-selected data-field; and
b. a BACK data-array selector for navigating to a parent data-array, said parent being an ancestor of said currently-selected data-array.
